(19) United States
(12) Patent Application Publication
(10) Pub. No.: US 2024/0071340 A1
(43) Pub. Date: Feb. 29, 2024

(54) Modular Guitar

(71) Applicant: Ian Williams, Menlo Park, CA (US)

(72) Inventor: Ian Williams, Menlo Park, CA (US)

(21) Appl. No.: 18/175,516

(22) Filed: Feb. 27, 2023

Related U.S. Application Data
(63) Continuation-in-part of application No. 29/866,070, filed on Aug. 26, 2022.
Application No. 29/866,070 is a continuation-in-part of application No. 29/866,072, filed on Aug. 26, 2022.

(51) Int. Cl. G10D 3/095; G10D 1/08; G10H 3/18

(52) U.S. Cl. CPC G10D 3/095; G10D 1/085; G10H 3/181; G10H 2220/461

(57) ABSTRACT

A modular guitar.

### BACKGROUND

This disclosure relates generally to musical instruments, and more particularly, to a modular guitar design. A modular instrument design can be desirable for ease of transport and for confidence in the integrity of the instrument when assembled.

### BRIEF DESCRIPTION OF THE DRAWINGS

FIG. 1 is a perspective view of a modular guitar in assembled form.

FIG. 2 is a perspective view of the frame for the modular guitar of FIG. 1.

FIG. 3 is a perspective view of the frame shown in FIG. 2 with a pickup module and a control module attached to the frame.

FIG. 4A is perspective view of an exemplary pickup module.

FIG. 4B is side view of the exemplary pickup module of FIG. 4A showing a connector for the pickups.

FIG. 5A is top view of an exemplary control module.

FIG. 5B is side view of the exemplary control module of FIG. 5A showing a connector for the controls.

### DETAILED DESCRIPTION

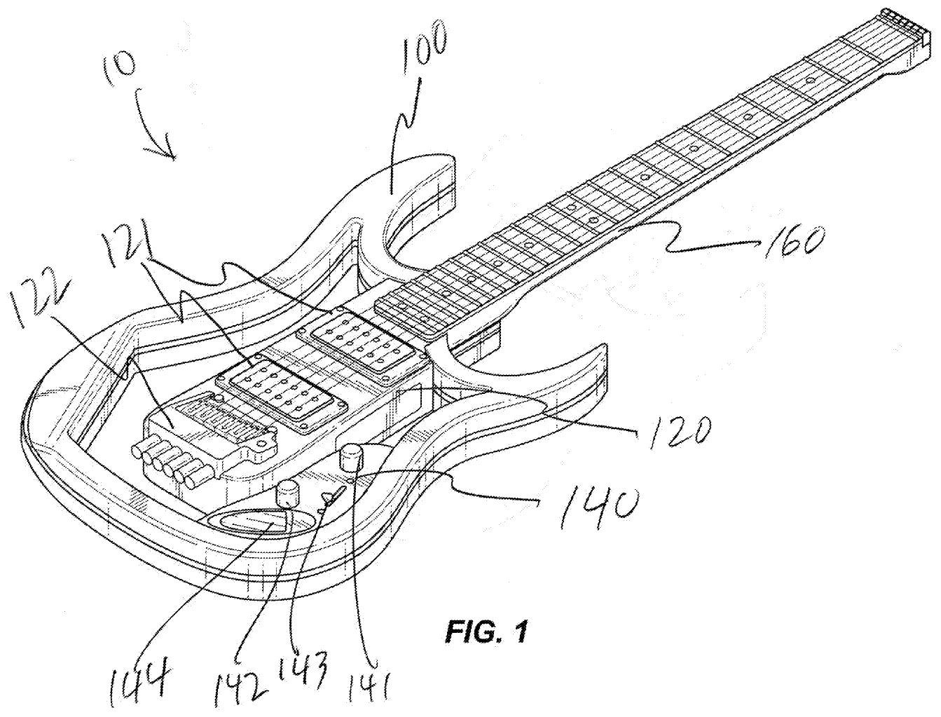

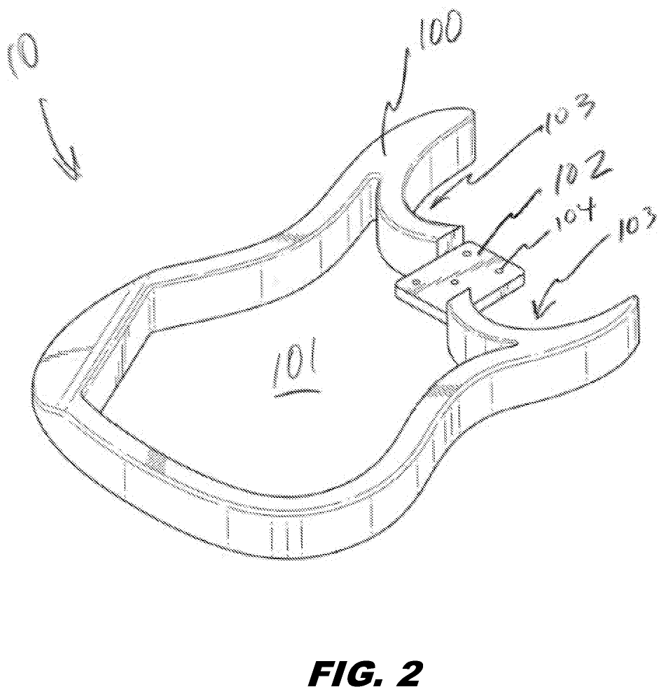

FIG. 1 illustrates one example of a modular electric guitar 10. The body 100 of guitar 10 has a double-cut design similar to a Stratocaster or S-style electric guitar. However, rather than a solid body design, the body 100 of modular guitar 10 is simply a peripheral frame of that S-style design, as shown in FIG. 2, with an open interior 101 defined by the body frame 100.

Removably attached within the body frame 100 are a pickup module 120 and a control module 140. A guitar neck 160 is removably attached to extend from the body frame in the usual manner.

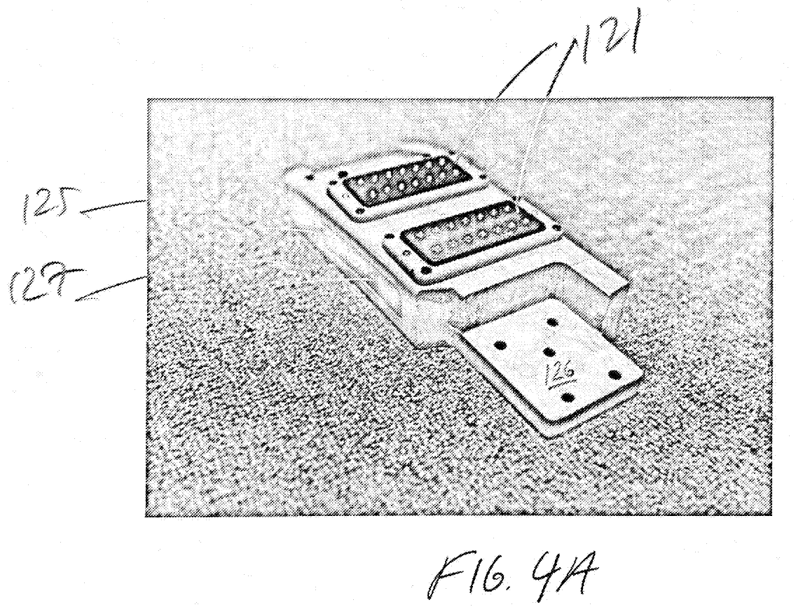

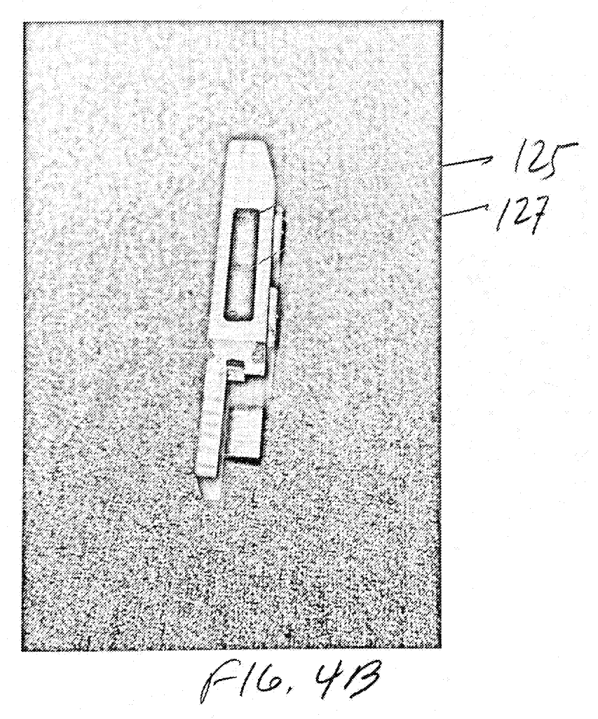

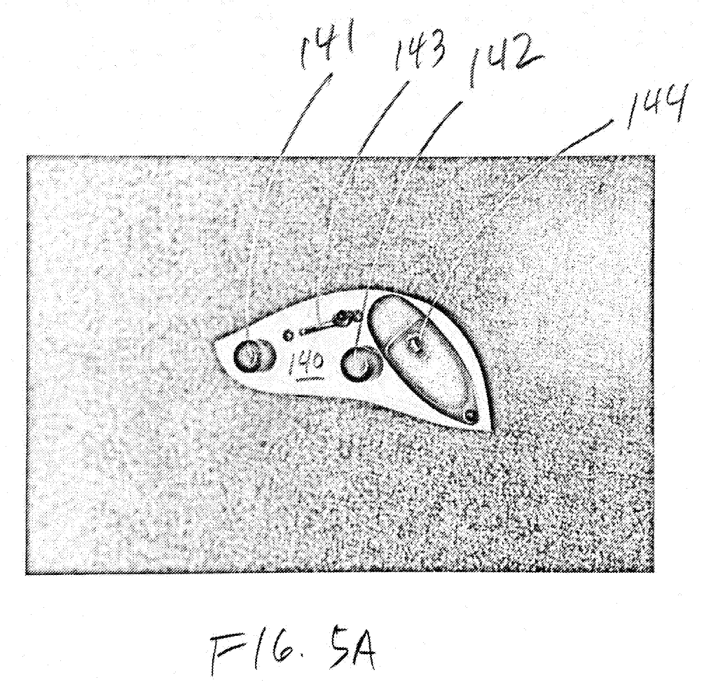

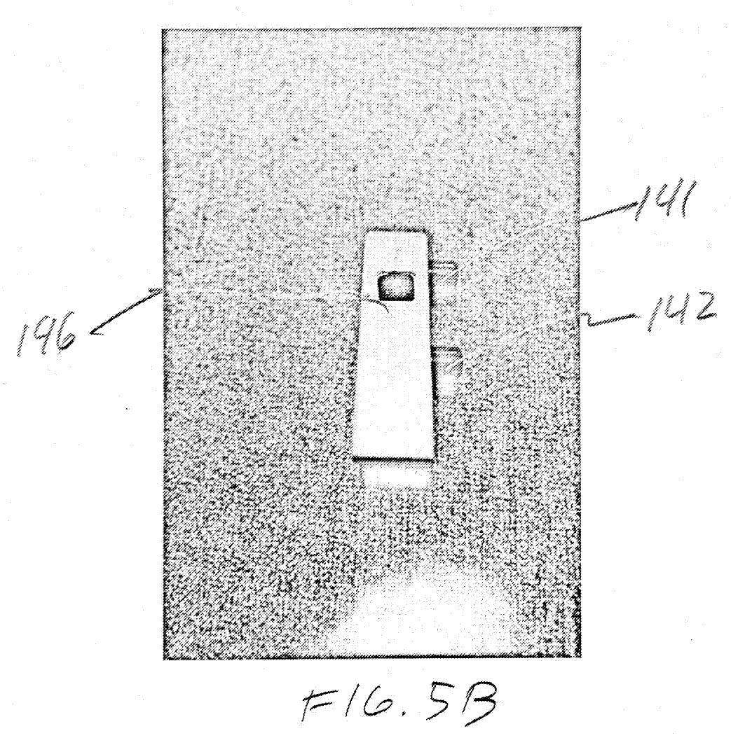

The control module 140 includes typical controls such as volume knob 141, tone knob 142, and pickup selector switch 143 on the top surface of the control module, and the module is electrically coupled to the pickup module 120, e.g., with a modular hard-wired connectors, for example as shown in FIGS. 4A-5B. An input jack 144 is provided for a standard ¼ inch plug connector.

The pickup module 120 includes electronic pickups 121 affixed in appropriate position and desired orientation in correspondence with the guitar strings, as well as a bridge assembly 122 for retaining and securing guitar strings in proper position, including in this “headless” configuration bridge/tuners.

It should be recognized that body frame could take many different shapes, and that many different types of pickup and control assemblies may implemented within a particular modular body frame without departing from the spirit and scope of this disclosure.

FIG. 2 shows the body frame 100 by itself, without the neck, pickup module and control module attached, thus revealing the extent of the empty interior portion 101 of the frame. A platform 102 is provided at the neck end of the body frame 100 between the double-cut portions 103 for attaching (and removing) the neck 160 and the pickup module 120, with through holes 104 for bolting the neck and pickup module in place at the platform.

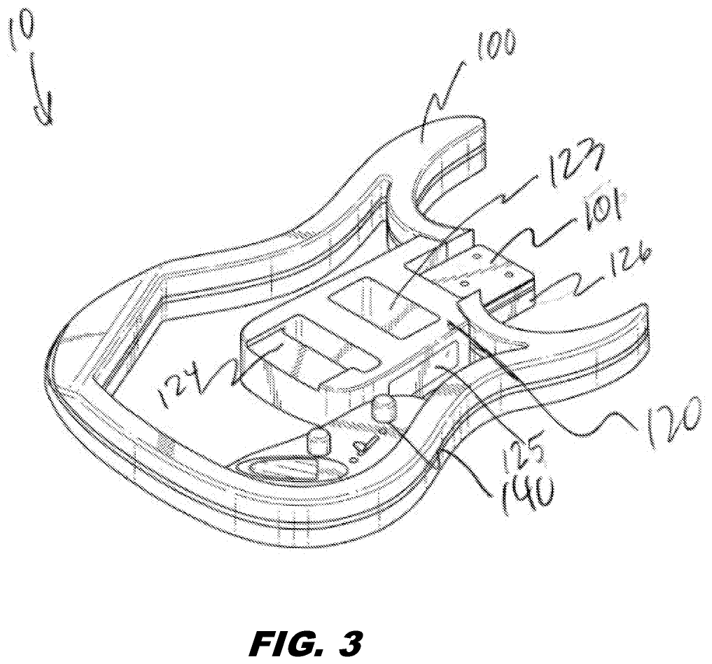

FIG. 3 shows the body frame 100 with pickup module 120 and control module 140 attached. The pickup module 120 has a cutout 123 for receiving pickups, a recess 124 (or second type of cutout) for attaching a bridge assembly, another cutout 125 on the side, and a tongue 126 extending from the module 120 for coupling with the platform 102 of the body frame 100 in bolt-on manner.

FIG. 4A shows the pickup module 120 with pickups 121 installed, and a connector 127 configured within a side opening 125 on the module (the side closest to the control module, preferably). FIG. 4B is a side view showing connector 125 having a three-terminal configuration, for electrically connecting with the pickups 121 in this particular configuration. Other configurations or connections may of course be used.

FIG. 5A is a top view of the control module 140, and the side view in FIG. 5B shows connector 146 for receiving a cable from the pickup module 120, and for electrically connecting with the volume knob 141, tone knob 142, and selector switch 143.

Many different configurations can be envisioned for coupling a basic frame, with a removable neck, pickups and controls. The foregoing description is merely one illustrative example of a guitar configuration.

1. A modular instrument, comprising:
a peripheral frame defining an interior space, the frame including a platform at a neck end of the frame;
a neck configured for removable coupling with the platform of the frame;
a pickup assembly configured for removable coupling with the platform of the frame; and
a control module configured for removable coupling with the frame.
